(19) United States
(12) Patent Application Publication
(10) Pub. No.: US 2015/0156983 A1
(43) Pub. Date: Jun. 11, 2015

(54) Multistage Live Lepidoptera Display and Containment System and Associated Methods

(71) Applicant: Kevin Michael Banach, Daytona Beach, FL (US)

(72) Inventor: Kevin Michael Banach, Daytona Beach, FL (US)

(21) Appl. No.: 14/201,804

(22) Filed: Mar. 8, 2014

Related U.S. Application Data
(60) Provisional application No. 61/963,680, filed on Dec. 11, 2013.

(51) Int. Cl. A01K 1/00

(52) U.S. Cl. CPC A01K 1/0035; A01K 1/0047

(57) ABSTRACT

The multistage live Lepidoptera containment display system includes a housing defining an observable interior Lepidoptera habitat. A ventilation feature is configured to provide sufficient ventilation within the housing for a Lepidopteran at various life stages including a pupa stage (e.g. chrysalis) and adult stage (e.g. butterfly). A Lepidopteran pupa attachment element is configured to attach a Lepidopteran pupa to an upper area of the housing and within the interior Lepidoptera habitat. A Lepidoptera release mechanism is configured to provide for release of the Lepidopteran from the interior Lepidoptera habitat within the housing after progressing from the pupa stage to the adult stage.

### CROSS-REFERENCE TO RELATED APPLICATIONS

This application claims the benefits of provisional patent application Ser. No. 61/963,680 filed Dec. 11, 2013, the entire disclosure of which is incorporated herein by reference.

### FIELD OF THE INVENTION

The present invention relates to the field of Lepidoptera (e.g. butterflies and moths) containment, and more particularly, to multistage live Lepidoptera displays.

### BACKGROUND

Lepidoptera are beautiful creatures that many people enjoy observing through the various stages of life-development. At the present time commercial options for using Lepidoptera in many different ways are fairly limited due to several issues such as portability, and safety for the Lepidoptera.

Lepidopterans live on every continent except Antarctica. There are many successful species in nearly every environment, from arid deserts and high mountaintops to marshes and tropical rainforests. A few Lepidoptera are directly beneficial to humans. Nearly all silk is obtained from the domesticated silkworm, which is originally from China. Many lepidopterans are valuable in biological research, including work in ecology, biogeography, systematics, genetics, and physiology. Much of the present knowledge of endocrine controls of insect. development has come from studies of the silkworm moth and its relatives. The study of the British peppered moth has profoundly influenced ideas about rates of evolutionary change.

Lepidopteran (order Lepidoptera) include more than 155,000 species of butterflies, moths, and skippers. This order of insects is second in size only to Coleoptera, the beetles. Because of their day-flying habits and bright colors, the butterflies are more familiar than the chiefly night-flying and dull-colored moths. The skippers are a worldwide group intermediate between butterflies and moths. With the exception of a few moths, all adult. lepidopterans have two pairs of wings. The name Lepidoptera is derived from the Greek, meaning “scaly winged,” and refers to the characteristic covering of microscopic scales on the wings.

The life cycle of lepidopterans includes four stages: egg, larva (caterpillar), pupa (chrysalis), and adult (imago). The larvae do most of the eating, with the majority feeding on foliage, although many species eat stems, roots, fruits, or flowers. The adults of many species are important for their role in pollination, which occurs as they visit flowers for nectar. In most land environments, the lepidopterans are ecologically important because they transform large amounts of plant matter into animal matter and in turn serve as food for many other groups of animals.

Moths, butterflies, and skippers show great diversity in size and development rates. Some moths have wingspans as small as 4 mm (0.13 inch), whereas the largest moths and butterflies measure nearly 30 cm (about 1 foot). Fast-developing species may complete their development in as little as three weeks, while slower ones may require as long as two or even three years.

Many members of the order, especially the butterflies, have appealed to the human imagination for thousands of years as symbols of fragile and ephemeral beauty, The are any references to butterflies in literature, and they have been depicted in many paintings, have inspired the designs of jewelry, ornaments, and textiles.

Live Lepidoptera pupae have been used as holiday tree ornaments, for example a product sold as “Live Butterfly Ornament”, by Flutterby Gardens (www.flutterbygardens.com) uses a live butterfly pupa and attaches it to a device for hanging on a Christmas tree. Although it does provide the chance for the end user to observe the pupae as well as a chance to witness the emergence of the butterfly, there are several issues that can arise from using Lepidoptera in such a way especially if the butterfly emerges without direct supervision.

Once emerged the adult butterfly may be faced with many possible perils such as flying into windows, coming into contact with pesticides, becoming lost behind household items, and being attacked by pets. Upon emergence from a pupal case, a butterfly must almost immediately hang in a nearly vertical position for an extended period of time. If the butterfly were unable to grasp the empty chrysalis it would fall. Unless it was able to find a suitable location with grip and spatial clearance sufficient to dry its wings properly, the butterfly would likely be rendered permanently flightless. Furthermore, many people are not comfortable handling live butterflies, and if handled improperly a fragile butterfly could suffer physical damage.

Live Lepidoptera have also been used as additions to floral pieces. In “Butterfly Arrangements” sold by Butterfly Wish Bouquets of New Castle, Pa. (www.butterflywishbouquets.com), living butterflies are added to floral pieces by covering the arrangements with netting and placing live butterflies inside. Although this can be an effective containment method, it has a major flaw limiting its commercial potential. Namely, the butterfly is able to come into contact with the flowers in the arrangement, and many commercially available cut flowers contain levels of pesticides capable of killing adult butterflies. Therefore, vegetation free of pesticides must be used, driving up cost and reducing potential availability.

Thus, the present inventor has recognized a need for a multistage live Lepidoptera containment display that is safe for the Lepidoptera as well as the observer.

### SUMMARY OF THE INVENTION

It is a goal of this invention to provide a safe environment where Lepidoptera pupae and adult Lepidoptera can be safely used as living decorative and educational pieces as well as additions to everyday and traditional displays, such as Christmas trees.

Is also an object of the present invention to provide a containment system for Lepidoptera species that will create a safe and suitable environment for the pupa and adult stages.

These, and other goals and objects, are provided by a multistage live Lepidoptera containment display system includes a housing defining an observable interior Lepidoptera habitat. A ventilation feature is configured to provide sufficient ventilation within the housing for a Lepidopteran at various life stages including a pupa stage (e.g. chrysalis) and adult stage (e.g. butterfly). A Lepidopteran pupa attachment element is configured to attach a Lepidopteran pupa to an upper area of the housing and within the interior Lepidoptera habitat. A Lepidoptera release mechanism is configured to provide for release of the Lepidoptera from the interior Lepidoptera habitat within the housing after progressing from the pupa stage to the adult stage.

The housing may include transparent globe, for example, having first and second halves connectable via a snap fit arrangement defining the Lepidoptera release mechanism. The ventilation feature may include a plurality of vent holes in the housing. Such plurality of vent holes are preferably positioned adjacent the Lepidopteran pupa attachment element in the upper area of the housing. The Lepidopteran pupa attachment element may be an adhesive.

A hanger element may be provided on the exterior of the housing. Also, a climbing feature may be affixed in the interior Lepidoptera habitat within the housing and configured to provide a climbing surface for an adult stage Lepidoptera to dry its wings. A removable base may be provided to support the housing.

A method aspect of the present invention is directed to making a multistage live Lepidoptera containment display system. The method includes providing a housing to define an observable interior Lepidoptera habitat, and forming a ventilation feature to provide sufficient ventilation within the housing for a Lepidopteran at various life stages including a pupa stage and adult stage. The method further includes installing a Lepidopteran pupa attachment element configured to attach a Lepidopteran pupa to an upper area of the housing and within the interior Lepidoptera habitat, and providing a Lepidoptera release mechanism configured to provide for release of the Lepidopteran from the interior Lepidoptera habitat within the housing after progressing from the pupa stage to the adult stage.

Accordingly, several advantages of the present embodiments include the prevention of injury to Lepidoptera from various household hazards including chemical hazards, the provision of adequate ventilation, and the elimination of a need to handle the Lepidoptera while still providing the opportunity for up-close observation while containing and displaying the Lepidoptera at various stages of development.

### BRIEF DESCRIPTION OF THE DRAWINGS

FIGS. 1A and 1B are perspectives views illustrating various aspects of a multistage live Lepidoptera containment display system in accordance with features of the present invention.

FIG. 2 is a perspective view of another embodiment of a Lepidoptera containment splay system with one half including an inside climbing structure.

FIG. 3 is a perspective view of another embodiment of a Lepidoptera containment display system with an example of a hanger attachment.

FIG. 4 is a perspective view of another embodiment of a Lepidoptera containment display system with an example of a removable base.

### DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. The dimensions of layers and regions may be exaggerated in the figures for ease of explanation.

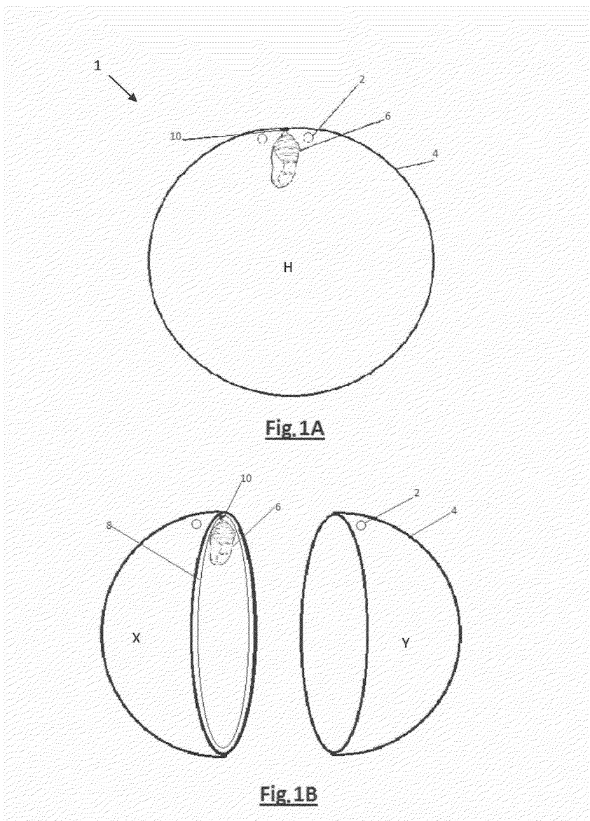

A multistage live Lepidoptera containment display system 1 according to a first embodiment will now be described with reference to FIGS. 1A and 1B. The system 1 includes a housing 4 defining an observable interior Lepidoptera habitat H. A ventilation feature 2 is configured to provide sufficient ventilation within the housing 4 for a Lepidopteran at various life stages including a pupa stage 6 (e.g. chrysalis) and adult stage (e.g. butterfly). A Lepidopteran pupa attachment element 10 is configured to attach a Lepidopteran pupa 6 to an upper area of the housing 4 and within the interior Lepidoptera habitat H. A Lepidoptera release mechanism 8 is configured to provide for release of the Lepidopteran from the interior Lepidoptera habitat H within the housing 4 after progressing from the pupa stage to the adult stage.

The housing 4 may be a transparent globe, for example, approximately 75-100 mm in diameter and made of plastic. Of course other sizes may be used as desired. The globe may have first and second halves X/Y connectable via a snap fit arrangement defining the Lepidoptera release mechanism 8. The ventilation feature 2 may include a plurality of vent holes in the housing. The housing 4 illustratively includes 2 vent holes but any number may be provided as needed to ensure adequate ventilation for the Lepidopteran at various life stages. Such plurality of vent holes are preferably positioned adjacent the Lepidopteran pupa attachment element 10 in the upper area of the housing 4. The Lepidopteran pupa attachment element 10 is preferably an adhesive.

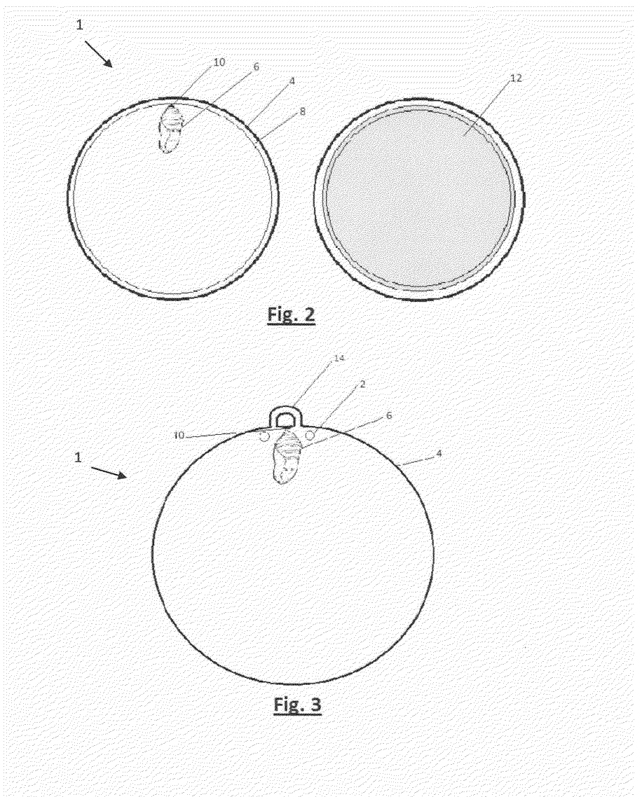

Referring now to FIG. 2, a climbing feature 12 is affixed in the interior Lepidoptera habitat H within the housing 4 and configured to provide a climbing surface for an adult stage Lepidoptera to dry its wings. The climbing feature 12 may be a textile layer such as cotton or any other suitable material that can provide enough grip for a Lepidoptera that has recently emerged from the chrysalis but fallen with the habitat H.

Referring now to FIG. 3, a hanger element 14 may be provided on the exterior of the housing 4. The hanger element 14, such as a half-loop of plastic, e.g. integrated or molded with the housing 4, provides for the attachment of the display system on an indoor plant, such as a Christmas tree. The system would then define an ornament and provide increased appeal to butterfly lovers. Such a “Live Lepidoptera Ornament” may also be manufactured in various shapes for different occasions and holidays.

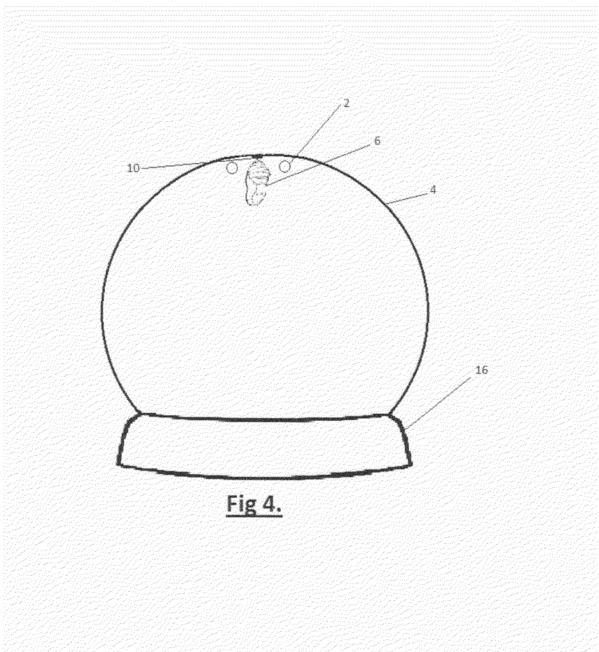

Referring now to FIG. 4, a removable base 16 may be provided to support the housing 4 for display, for example, on a table or shelf.

Accordingly, it should be clear that the containment systems of the various embodiments can be used to safely house and display living Lepidoptera in both the pupa and adult stages. The system will serve as a barrier to a wide variety of hazards associated with the home such as exposure to pesticides, becoming lost in the home, attacks from animals and flying into windows. Furthermore, the containment system has additional advantages in that it permits the commercialization of live Lepidoptera without the problems pesticides have caused in the past, it allows a means of safe, up close viewing of live Lepidoptera pupae and adult Lepidoptera, it allows adequate airflow for Lepidoptera, it provides a surface suitable for climbing, it provides adequate ventilation for Lepidoptera, and it has pieces which open allowing for the safe release of Lepidoptera, for example.

Although the description above contains many specifications, these should not be construed as limiting the scope of the embodiments but as merely providing illustrations of some of several embodiments. For example, the system can have other shapes, for example an egg, heart, star, oval, triangle, trapezoidal, triangular, octagonal, rectangular, bell, or cube shape. The groove can be replaced by a hinge which connects two otherwise unconnected halves etc.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope herein.

That which is claimed is:

1. A multistage live Lepidoptera containment display system comprising;
a housing defining an observable interior Lepidoptera habitat;
a ventilation feature configured to provide sufficient ventilation within the housing for a Lepidopteran at various life stages including a pupa stage and adult stage;
a Lepidopteran pupa attachment element configured to attach a Lepidopteran pupa to an upper area of the housing and within the interior Lepidoptera habitat; and
a Lepidoptera release mechanism configured to provide for release of the Lepidopteran from the interior Lepidoptera habitat within the housing after progressing from the pupa stage to the adult stage.

2. The multistage live Lepidoptera containment display system according to claim 1 wherein the housing comprises a transparent globe.

3. The multistage live Lepidoptera containment display system according to claim 2 wherein the transparent globe comprises first and second halves connectable via a snap fit arrangement defining the Lepidoptera release mechanism.

4. The multistage live Lepidoptera containment display system according to claim 1 wherein the ventilation feature comprises a plurality of vent holes in the housing.

5. The multistage live Lepidoptera containment display system according to claim 4 wherein the plurality of vent holes are positioned adjacent the Lepidopteran pupa attachment element in the upper area of the housing.

6. The multistage live Lepidoptera containment display system according to claim 1 wherein the Lepidopteran pupa attachment element comprises an adhesive.

7. The multistage live Lepidoptera containment display system according to claim 1 further comprising a hanger element on the exterior of the housing.

8. The multistage live Lepidoptera containment display system according to claim 1 further comprising a climbing feature in the interior Lepidoptera habitat within the housing and configured to provide a climbing surface for an adult stage Lepidoptera to dry its wings.

9. The multistage live Lepidoptera containment display system according to claim 1 further comprising a removable base configured to support the housing.

10. A multistage live Lepidoptera containment display system comprising:
a housing comprising a transparent globe and defining an observable interior Lepidoptera habitat;
a hanger element on the exterior of the housing and configured to hang the housing for display;
a ventilation feature comprising a plurality of vent holes in the housing and configured to provide sufficient ventilation within the housing for a Lepidopteran at various life stages including a pupa stage and adult stage;
a Lepidopteran pupa attachment element comprising an adhesive and configured to attach a Lepidopteran pupa to an upper area of the housing and within the interior Lepidoptera habitat; and
a Lepidoptera release mechanism configured to provide for release of the Lepidopteran from the interior Lepidoptera habitat within the housing after progressing from the pupa stage to the adult stage;
the transparent globe comprising first and second connectable halves defining the Lepidoptera release mechanism.

11. The multistage live Lepidoptera containment display system according to claim 10 further comprising a climbing feature in the interior Lepidoptera habitat within the housing and configured to provide a climbing surface for an adult stage Lepidoptera to dry its wings.

12. The multistage live Lepidoptera containment display system according to claim 10 werein the plurality of vent holes are positioned adjacent the Lepidopteran pupa attachment element in the upper area of the housing.

13. A method of making a multistage live Lepidoptera containment display system, the method comprising:
providing a housing to define an observable interior Lepidoptera habitat;
arming a ventilation feature to provide sufficient ventilation within the housing for a Lepidopteran at various life stages including a pupa stage and adult stage;
installing a Lepidopteran pupa attachment element configured to attach a Lepidopteran pupa to an upper area of the housing and within the interior Lepidoptera habitat; and
providing a Lepidoptera release mechanism configured to provide for release of the Lepidopteran from the interior Lepidoptera habitat within the housing after progressing from the pupa stage to the adult stage.

14. The method according to claim 13 wherein the housing comprises a transparent globe including first and second halves connectable via a snap fit arrangement defining the Lepidoptera release mechanism.

15. The method according to claim 13 wherein forming the ventilation feature comprises creating a plurality of vent holes in the housing.

16. The method according to claim 15 wherein the plurality of vent holes are positioned adjacent the Lepidopteran pupa attachment element in the upper area of the housing.

17. The method according to claim 13 wherein installing the Lepidopteran pupa attachment element comprises applying an adhesive to the upper area of the housing and within the interior Lepidoptera habitat.

18. The method according to claim 13 further comprising providing a hanger element on the exterior of the housing.

19. The method according to claim 13 further comprising affixing a climbing feature in the interior Lepidoptera habitat within the housing and configured to provide a climbing surface for an adult stage Lepidoptera to dry its wings.

20. The method according to claim 13 further comprising supplying a removable base configured to support the housing.
